(19) United States
(12) Patent Application Publication
(10) Pub. No.: US 2014/0092894 A1
(43) Pub. Date: Apr. 3, 2014

(54) METHOD AND APPARATUS TO DERIVE SYSTEM TIMING AT A WIRELESS BASE STATION

(71) Applicants: David Rossetti, Murray Hill, NJ (US); Satish Kanugovi, Bangalore (IN)

(72) Inventors: David Rossetti, Murray Hill, NJ (US); Satish Kanugovi, Bangalore (IN)

(73) Assignee: ALCATEL LUCENT, Paris (FR)

(21) Appl. No.: 13/995,791

(22) PCT Filed: Dec. 7, 2011
(86) PCT No.: PCT/IB11/03188

§ 371 Date: Dec. 12, 2013

(30) Foreign Application Priority Data
Dec. 23, 2010 (IN) 3940/CHE/2010

(51) Int. Cl. H04W 56/00

(52) U.S. Cl. CPC H04W 56/0065
USPC 370/350

(57) ABSTRACT

Method and Apparatus to Derive System Timing at a Wireless Base transceiver Station (BTS). The present invention relates to wireless communication networks and, more particularly, to timing information in wireless communication networks. A method for providing reference timing to a BTS, the method comprising of the BTS sending a message to a network controller via a station, wherein the message requests for round trip delay time incurred by the message; the BTS estimating a timing offset from a response and determining the correction to be made to the reference timing using the timing offset due to the one way delay from the station transmitting the pilot signal, the actual PN offset at which the station transmits the pilot signal and the actual offset at which the pilot signal is received at the BTS; and the BTS making the correction to the reference timing.

### TECHNICAL FIELD

The present invention relates to wireless communication networks and, more particularly, to timing information in wireless communication networks.

### BACKGROUND

Timing information is essential for mobile terminals and base transmitting stations (BTSs) in a communication network. BTSs in a CDMA system are identified by a unique timing offset also called as Pseudo-noise (PN) offset, which is relative to the neighboring BTSs. A unique PN offset assigned to a particular BTS is used to offset the pilot signal broadcast by the BTS relative to a designated zero offset pilot signal. Consider an example where a mobile terminal receives a pilot signal from the BTS. The pilot signal may have a non-zero offset timing applied to it. The mobile terminal determines and reports the pilot PN offset in addition to the signal strength of the received pilot signal to the network controller. It is to be noted that the pilot PN offset measured by the mobile terminal will be slightly different from the PN offset applied by the BTS because of the time delay for the signal to travel from the BTS to the mobile terminal. The network controller derives the identity of the BTS from the reported PN offset and along with the reported signal strength, uses it to select the appropriate BTS for call processing procedures. For the call processing procedures to succeed, it is important that the pilot PN offset is accurately measured by the mobile terminal, so that the network controller determines the correct BTS based on the reported pilot PN offset. This requires that the timing reference at the base station be accurate, so that the mobile can make correct estimation of the PN offset of the pilot signal transmitted by the BTS. If the timing reference is not accurate, the PN offset determined by the mobile terminal can be different from what is actually applied by the BTS. Hence, the mobile terminal will report an incorrect PN offset to the network controller, which in turn might choose an incorrect BTS for call processing.

A mobile terminal receives a pilot signal from a BTS, where the pilot signal has a non-zero offset. The mobile terminal also receives the value of the offset that has been applied to the pilot signal by the BTS along with the one way delay between the mobile terminal and the BTS using suitable signaling means. The mobile terminal estimates the PN offset at which it should be receiving the pilot signal from the known PN offset and the one way delay provided by the signaling message. The mobile terminal determines the drift in the reference time at the BTS by comparing the value of the received (measured by the mobile station) PN offset with the estimated PN offset (derived from PN offset information+the one way delay with the BTS, in the signaling message).

In a typical time synchronized network like CDMA, the BTSs are provided the timing reference by external sources like GPS. However, since BTSs may be deployed in closed spaces (for example, within office buildings, residential buildings, warehouses etc), they may not necessarily be able to receive GPS signals to maintain accurate timing information. This leads to drift in the pilot signal transmissions by the BTS, which when measured and reported by the mobile terminal leads to inaccurate identification of the BTS at the network controller.

### SUMMARY

In view of the foregoing, an embodiment herein provides a method for providing accurate reference timing to a base transceiver station, the method comprising of the base transceiver station sending a message to a station, wherein the message may be a signaling message and requests for round trip delay time incurred by the message; the base transceiver station estimating a timing offset from a response to the message; the base transceiver station determining offset at which a pilot signal is received from the station; the base transceiver station determining correction to be made to the reference timing using the timing offset and the determined offset of the pilot signal; and the base transceiver station making the correction to the reference timing. The station may be one of a second base transceiver station which has accurate reference timing; a second base transceiver station which has Global Positioning Satellite time; and a femto base station. The method further comprising of the station computing round trip delay of the message on receiving the message; the station sending the round trip delay time to a network controller; and the network controller sending the response to the base transceiver station, which comprises of the round trip delay time; and identity of the station. The base transceiver station may determine information of the pilot and offset of pilot of the reference by monitoring pilot channel from the station The base transceiver station may determine reference timing on at least one of receiving a request from a mobile terminal; detecting movement of the base transceiver station using an accelerometer; pre-determined intervals of time; and a function of a time reference quality indication provided by the station.

Embodiments herein further disclose a base transceiver station comprising at least one means configured for sending a message to a station, wherein the message requests for round trip delay time suffered by the message; estimating a timing offset from a response to the message; determining offset at which a pilot signal is received from the station; determining correction to be made to the reference timing using the timing offset and the determined offset of the pilot signal; and making the correction to the reference timing. The base transceiver station comprises a means configured for send the message to the station, wherein the station is one of a second base transceiver station which has accurate reference timing; a second base transceiver station which has Global Positioning Satellite time; and a femto base station. The base transceiver station comprises a means configured for determining offset of the pilot signal received from the station by monitoring pilot channel from the station. The base transceiver station comprises a means configured for determining reference timing on at least one of receiving a request from a mobile terminal for reference timing; detecting movement of the base transceiver station which may be done using an accelerometer; pre-determined intervals of time; and a function of a time reference quality indication provided by the station.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 depicts an integrated BTS in a communication network, according to embodiments as disclosed herein;

FIG. 2 depicts an integrated BTS, according to embodiments as disclosed herein; and

FIG. 3 is a flowchart illustrating the process of estimating the system time, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

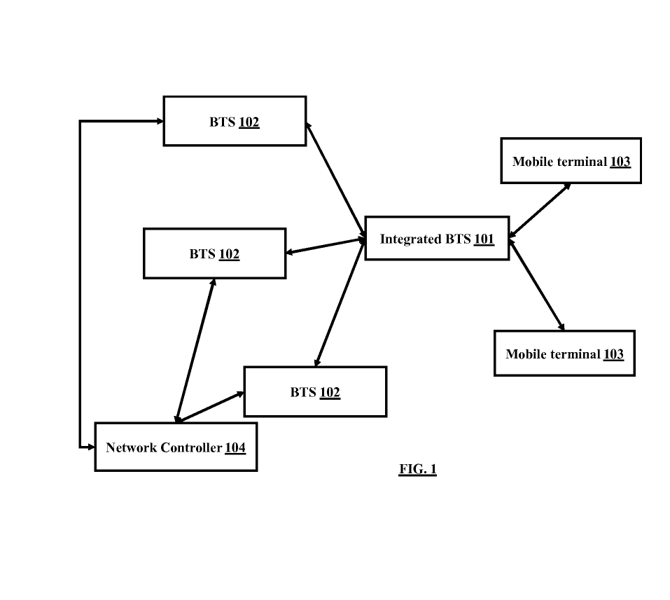

The embodiments herein disclose a method and system to provide accurate reference timing to a base transceiver station (BTS). Referring now to the drawings, and more particularly to FIGS. 1 through 3, where similar reference characters denote corresponding features consistently throughout the figures, there are shown embodiments.

FIG. 1 depicts an integrated base transceiver station within a communication network, according to embodiments as disclosed herein. The figure as depicted comprises of an integrated BTS 101, a plurality of base transceiver stations 102, a network controller 104 and a plurality of mobile terminals 103. The integrated BTS 101 may be a macro BTS, a femto base station or any device capable of acting as a base station. The integrated BTS 101 is connected to the other BTSs in a manner similar to a mobile terminal connecting to a BTS, where the mobile terminal is within the coverage area of the BTS. The integrated BTS 101 may be visible to a plurality of BTSs 102 at the same time. The integrated BTS 101 may also be connected to at least one mobile terminal 103. The BTSs 102 may be connected to a network controller 104. The BTSs 102 may be connected to more than one network controller; i.e., one or more BTSs may be connected to a first network controller 104 and other BTSs 102 visible to the integrated BTS 101 may be connected to a second network controller 104. The BTSs 102 may also be integrated base stations 101.

The integrated BTS 101 may communicate with one of the BTSs 102. The integrated BTS 101 monitors the local wireless channel from that BTS 102 and may also communicate with the local wireless macro network. The integrated BTS 101 may request the network controller 104 using a message to provide round trip delay time of the message that was sent by the integrated BTS 101 to the network controller 104 via the BTS 102. The BTS 102 forwards the message along with the round trip delay incurred by the message to the network controller 104. The network controller 104 sends the round trip delay incurred by the message along with the identity of the BTS 102 (pilot PN offset assigned to BTS 102—this is the same pilot PN offset that BTS 102 applies while transmitting the pilot signal over the air) to the integrated BTS 101. The message containing the round trip delay time will be received by the integrated BTS101 and the integrated BTS 101 will use the received round trip delay time to estimate a timing offset to the BTS 102, where the timing offset is the offset at which the integrated BTS 101 should receive the pilot signal from the BTS 102, if the integrated BTS 101 had an aligned clock. The integrated BTS 101 may monitor the pilot channel of the BTS 102 to determine the time the pilot signal is received from the BTS 102. The integrated BTS 101 compares the timing offset with the timing offset at which the pilot signal is actually received to determine by how much time the internal clock of the integrated BTS 101 is adrift. The integrated BTS 101 may now align its internal clock (reference timing) with the system time. The integrated BTS 101 may now attempt to keep its internal clock accurate by repeating the procedures thus mentioned, keeping the timing offset of the broadcast pilot signal fixed.

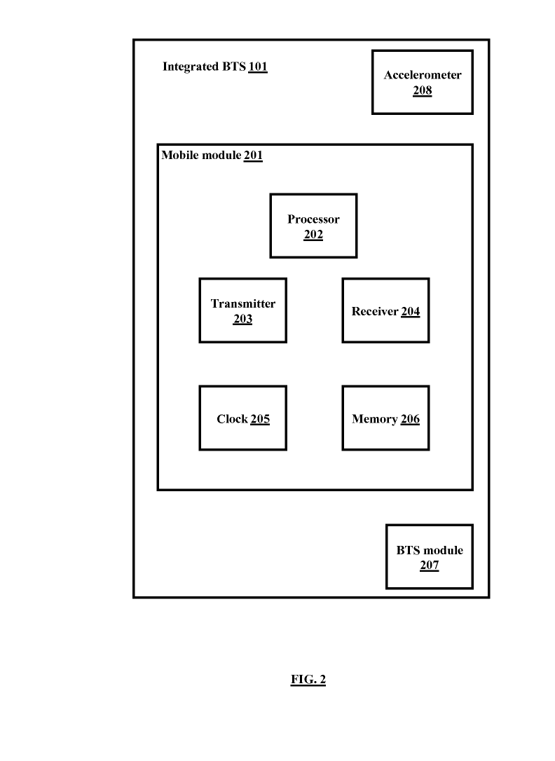

FIG. 2 depicts an integrated BTS, according to embodiments as disclosed herein. The integrated BTS 101 comprises of a BTS module 207 and a mobile module 201. The integrated BTS 101 may further comprise of an accelerometer 208. The mobile module 201 further comprises of a processor 202, a transmitter 203, a receiver 204, a clock 205 and a memory 206. The mobile module 201 enables the integrated BTS 101 to connect to other modules such as BTSs, integrated BTSs, and femto base stations in a manner similar to a mobile terminal connecting to a BTS/base station.

The processor 202 checks if a communication signal is present. The communication signal may be from a BTS 102, a femto base station, an integrated BTS 101 which has reference timing or another integrated BTS 101 which has GPS time. If more than one communication signal is present, the processor 202 selects a communication signal as reference using a suitable means with the help of additional information. In another embodiment herein, the processor 202 may select more than communication signal as references. The suitable means may also be an appropriate server over the internet. The additional information may comprise of a priority list of carrier number, band class, pilots of candidate references and so on.

Consider that the processor 202 has selected a BTS 102 as reference. The processor 202 sends a signaling message to the network controller 104 via the BTS 102 using the transmitter 203. The signaling message requests the network controller 104 to provide a round trip delay with respect to the integrated BTS 101.

The processor 202 receives a response message from the network controller 104 via the BTS 102 and the receiver 204, which comprises of the round trip delay of the signaling message received from the integrated BTS 101. The response message may also comprise of a time reference quality indication which indicates how well the BTS 102 believes it is keeping time. The response message also comprises of the identity of the BTS 102. The processor 202 computes the expected timing offset of at which the pilot signals from BTS102 should be received from the round trip delay as present in the response message and stores the timing offset in the memory 206. The processor 202 may compute the timing offset as the one way delay, which is half of the round trip delay. The processor 202 further monitors the paging/control channel of the BTS 102 to determine the time the pilot signal is received from the BTS 102. The processor 202 compares the timing offset with the time the pilot signal is received to determine by how much time the internal clock of the integrated BTS 101 is offset. Once the processor 202 has determined the actual pilot offset of the BTS 102, the processor 202 aligns its internal clock with the reference timing as provided by the BTS 102, using the estimated timing offset, received pilot timing and the pilot offset. The processor 202 may store the reference timing in the clock 205. In an embodiment herein, the processor 202 may keep its internal clock slaved to the pilot timing, while keeping the timing offset constant. The processor 202 may make further determinations of the internal clock, as required, on receiving a request from a mobile terminal 103 or at periodic intervals of time.

In an embodiment herein, if the accelerometer 208 detects that the integrated BTS 101 has moved, the accelerometer informs the movement to the processor 202. The processor 202 may then make a determination of the adjustment that needs to be applied, due to the motion of the BTS101, to the internal clock.

In an embodiment herein, if the accelerometer 208 detects that the integrated BTS 101 has moved, the accelerometer informs the movement to the processor 202. The processor 202 may then restart the operations.

In an embodiment herein, the frequency at which the processor 202 makes ping measurements is a function of the time reference quality provided by the BTS 102.

In an embodiment herein, the processor 102 may send signaling messages to a plurality of references, where the references may be a BTS 102, a femto base station which has reference timing, a femto base station which has GPS time, an integrated BTS 101 which has reference timing or another integrated BTS 101 which has GPS time. The processor 202 may then use filtering techniques to estimate timing offset for each reference. Kalman filters may be used for filtering by the processor 202.

Embodiments as disclosed herein can be in conjunction with other means like NTP to align the internal clock of the integrated BTS 101.

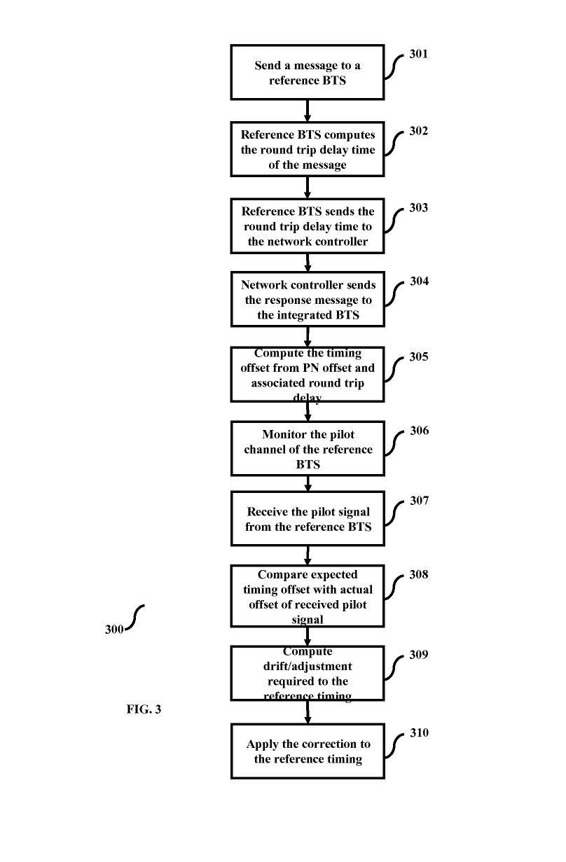

FIG. 3 is a flowchart illustrating the process of estimating the system time, according to embodiments as disclosed herein. The integrated BTS 101 sends (301) a message to the reference BTS 102, where the message may be a signaling message. The reference BTS 102 on receiving the signaling message computes (302) the round trip delay time incurred by the signaling message and sends (303) the signaling message along with the round trip delay to the network controller 104. The network controller 104 then sends (304) the message comprising of the round trip delay time to the integrated BTS 101. On receiving the message comprising of the round trip delay time from the network controller 104 via the BTS 102, the integrated BTS 101 computes (305) the timing offset from the round trip delay as present in the response message and the PN offset. The integrated BTS 101 may compute the timing offset as the one way delay, which is half of the round trip delay. The integrated BTS 101 further monitors (306) the pilot channel of the reference BTS 102. On the integrated BTS 101 receiving (307) the pilot signal from the reference BTS 102, the integrated BTS 101 compares (308) the expected timing offset with the offset of the pilot signal received from the reference BTS 102 to compute (309) the adjustment required to be made to the reference timing by comparing the timing offset with the time the pilot signal is received. Once the integrated BTS 102 has determined the adjustment, the integrated BTS 101 applies (310) the correction to the reference timing. The various actions in method 300 may be performed in the order presented, in a different order or simultaneously. Further, in some embodiments, some actions listed in FIG. 3 may be omitted.

The embodiments disclosed herein can be implemented through at least one software program running on at least one hardware device and performing network management functions to control the network elements. The network elements shown in FIGS. 1 and 2 include blocks which can be at least one of a hardware device, or a combination of hardware device and software module.

Embodiments herein disclose a method and system to provide accurate reference timing to mobile terminals connected to a BTS. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a code written in e.g. Very high speed integrated circuit Hardware Description Language (VHDL) or any other coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

We claim:

1. A method for providing accurate reference timing to a base transceiver station, said method comprising of
Said base transceiver station sending a message to a station, wherein said message comprises a request for round trip delay time incurred by said message;
Said base transceiver station estimating a timing offset from a response to said message;
Said base transceiver station determining offset of at which a pilot signal is received from said station;
Said base transceiver station determining correction to be made to reference timing using said timing offset and determined offset of said pilot signal; and
Said base transceiver station making said correction to said reference timing.

2. The method, as claimed in claim 1, wherein said message is a signaling message.

3. The method, as claimed in claim 1, wherein said station is at least one of
a second base transceiver station which has accurate reference timing;
a second base transceiver station which has Global Positioning Satellite time; and
a femto base station.

4. The method, as claimed in claim 1, wherein said method further comprising of
Said station computing round trip delay of said message on receiving said message;
Said station sending said round trip delay time to a network controller; and
Said network controller sending said response to said base transceiver station.

5. The method, as claimed in claim 4, wherein said response comprises of
Said round trip delay time; and
Identity of said station.

6. The method, as claimed in claim 1, wherein said base transceiver station determines offset of at which a pilot signal is received from said station by monitoring pilot channel from said station.

7. The method, as claimed in claim 1, wherein said base transceiver station determines reference timing on at least one of
Receiving a request from a mobile terminal;
Detecting movement of said base transceiver station;
Pre-determined intervals of time; and
A function of a time reference quality indication provided by said station.

8. The method, as claimed in claim 7, wherein an accelerometer detects movement of said base transceiver station.

9. A base transceiver station comprising at least one means configured for
sending a message to a station, wherein said message comprises of a request for round trip delay time incurred by said message;
estimating a timing offset from a response to said message;
determining offset at which a pilot signal is received from said station;
determining correction to be made to said reference timing using said timing offset and determined offset of said pilot signal; and
making said correction to said reference timing.

10. The base transceiver station, as claimed in claim 9, wherein said base transceiver station comprises a means configured for send said message to said reference, wherein said station is at least one of
a second base transceiver station which has accurate reference timing;
a second base transceiver station which has Global Positioning Satellite time; and
a femto base station.

11. The base transceiver station, as claimed in claim 9, wherein said base transceiver station comprises a means configured for determining offset of at which a pilot signal is received from said station by monitoring pilot channel from said station.

12. The base transceiver station, as claimed in claim 9, wherein said base transceiver station comprises a means configured for determining reference timing on at least one of
Receiving a request from a mobile terminal for reference timing;
Detecting movement of said base transceiver station;
Pre-determined intervals of time; and
A function of a time reference quality indication provided by said station.

13. The base transceiver station, as claimed in claim 12, wherein said base transceiver station comprises an accelerometer.
